(19) United States
(12) Patent Application Publication
(10) Pub. No.: US 2009/0263760 A1
(43) Pub. Date: Oct. 22, 2009

(54) ABUTMENT FOR IMPLANT

(76) Inventors: Sung-Min Chung, Seoul (KR); Sun-Do Cho, Gwangmyeong-city (KR); Koo-Yeol Yoon, Anyang-city (KR); In-Ho Kim, Gunpo-city (KR); Hyon-keun Lee, Sacheon-city (KR)

Correspondence Address: CHRISTOPHER PAUL MITCHELL, 888 16TH ST., NW, SUITE 800, WASHINGTON, DC, 20006, US

(21) Appl. No.: 11/993,856

(22) PCT Filed: Oct. 5, 2005
(86) PCT No.: PCT/KR2005/003285

§ 371 Date: Dec. 21, 2007

(30) Foreign Application Priority Data
Jun. 22, 2005 (KR) 10 2005 00542208

(51) Int. Cl. A61C 8/00

(52) U.S. Cl. 433/173

(57) ABSTRACT

In an abutment for a dental implant which includes a crown connection part, a smooth tissue contact part and a fixture engaging part, there is provided an improved abutment for a dental implant characterized in that only the smooth tissue contact part is coated. The abutment is made of titanium. The coating process is performed with TiN.

### TECHNICAL FIELD

The present invention relates to an abutment for an implant which is formed of a crown connection part, a smooth tissue contact part and a fixture engaging part, and in particular to an abutment for an implant which is capable of enhancing an engaging force with respect to a crown and a fixture in such a manner that a smooth tissue contact part is coated, while a crown connection part and a fixture engaging part are not coated.

### BACKGROUND ART

An implant is a dental prosthesis, which has been generally used for substituting teeth when a tooth has a problem or is lost. The implant may be used without damaging neighboring teeth. It has many advantages in medical treatment effects with a relatively long life span. The implant is planted after a hole is formed at an alveolar bone of a patient using a drill. Here, drilling an alveolar bone of a patient is very important. An artificial tooth root, called a fixture, is planted at an alveolar bone without teeth, with the fixture being made of titanium, which does not have any side effects with respect to a human body, so that the fixture can be used as a tooth root of the lost tooth. An artificial tooth, called a crown, is fixed at an artificial tooth root by an abutment process, so that an inherent function of a tooth is recovered. In the case of a common dental prosthesis or denture, teeth and bones are damaged after a certain time period passes, while the implant does not damage neighboring teeth tissues. The implant has the same functions and shapes as natural teeth. The implant does not have a tooth decay problem, so that it can be used permanently. The dental implant includes a fixture which is embedded in upper and lower alveolar bones (hereinafter referred to as alveolar bones) of damaged teeth parts together with natural tooth roots for thereby supporting artificial tooth crowns, an abutment engaged with the fixture, and a crown which is fixed in a mouth using the abutment, so that the implant has the same shapes and functions as a natural tooth. With the above constructions, the fixture is fully fixed at the alveolar bone line a natural tooth root. The abutment is connected with the fixture of the implant using an abutment, and an artificial crown is engaged at a crown connection part for thereby finishing an implant. In the conventional implant abutment, the crown connection part, the smooth tissue contact part and the fixture engaging part are all made of titanium, and the resultant structure is coated with TiN (Titanium nitride). The whole portions of the implant abutment are coated with TiN in order to prevent the discharge of titanium ions and to enhance an anti-abrasion property by increasing a surface hardness. In addition, it is possible to meet a patient's common color attractiveness as many people are in favor of gold color for their teeth. Effectively coping with a smooth tissue reaction is easy. However, in the conventional implant abutment, a slip problem may occur between a fixture engaging part and a fixture and between a crown connection part and a crown since the whole portions of the crown connection part, the smooth tissue contact part and the fixture engaging part are coated with TiN₁ so that an engaging force may lose at the fixture and the crown.

### DISCLOSURE OF INVENTION

Accordingly, it is an object of the present invention to provide an abutment for an implant which is capable of enhancing an engaging force of a crown and a fixture in such a manner that a slip problem is prevented between a fixture engaging part and a fixture and between a crown connection part and a crown in an implant abutment construction which includes a crown connection part, a smooth tissue contact part, and a fixture engaging part. To achieve the above object, in an abutment for a dental implant which includes a crown connection part, a smooth tissue contact part and a fixture engaging part, there is provided an improved abutment for a dental implant characterized in that only the smooth tissue contact part is coated. The abutment is made of titanium. The coating process is performed with TiN.

### BRIEF DESCRIPTION OF THE DRAWINGS

FIG. 1 is a view illustrating a constriction of an abutment for implant according to the present invention;

FIG. 2 is a partial cut-away perspective view illustrating a construction that an abutment for implant is coupled to a fixture according to the present invention; and

FIG. 3 is a view illustrating a construction of an abutment for implant according to another embodiment of the present invention.

### BEST MODE FOR CARRYING OUT THE INVENTION

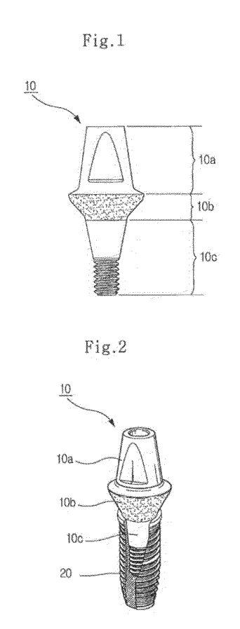

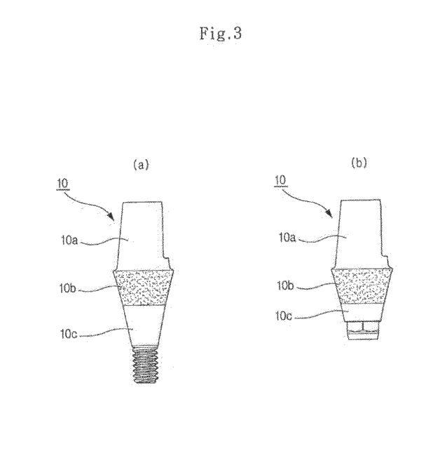

FIG. 1 is a view illustrating a constriction of an abutment 10 for implant according to the present invention; and FIG. 2 is a partial cut-away perspective view illustrating a construction that an abutment 10 for implant is coupled to a fixture 20 according to the present invention, and FIG. 3 is a view illustrating a construction of an abutment 10 for implant according to another embodiment of the present invention. The implant abutment 10 according to the present invention is a kind of a dental prosthesis used to substitute a tooth, which has a problem or is lost. The abutment can be planted without damaging neighboring teeth and has a long time life span. As shown in FIGS. 1 through 3, the implant abutment 10 has a crown connection part 10a of which a crown (not shown) is covered on an upper side of the implant abutment 10. A smooth tissue contact part 10b is formed at an intermediate portion of the same, with a smooth tissue contacting with the smooth tissue contact part 10b. A fixture engaging part 10c is formed at a lower side of the same and is engaged into a fixture 20. The implant abutment 10 according to the present invention is planted at an alveolar bone using the fixture engaging part 10c, with a tooth being removed from the alveolar bone, and is engaged into the osseointegrated fixture 20. A crown (not shown) having the same function as a natural tooth is connected with the crown connection part 10a. Namely, the fixture 20 is fully fixed at the alveolar bone like a root of a natural tooth and is osseointegrated. The fixture engaging part 10c of the abutment 10 is engaged at an upper inner side of the fixture 20 of the implant 20, so that the smooth tissue connection part 10b contacts with a smooth tissue of a gum, and the crown is engaged at the crown connection part 10a for thereby finishing an implant artificial tooth. In addition, the implant abutment 10 according to the present invention is preferably made of titanium, which has an excellent strength and an anti-corrosion property with the implant abutment 10 being formed of the crown connection part 10a, the smooth tissue contact part 10b, and the fixture engaging part 10c. In the case of the implant abutment 10 according to the present invention, only the smooth tissue contact part 10b is coated, while the crown connection part 10a and the fixture engaging part 10c are not coated. If the crown connection part 10a, and the fixture engaging part 10c are coated, a slip problem may occur because the engaged surfaces between the fixture engaging part 10c and the fixture 20 and between the crown connection part 10a and the crown are slippery. In this case, the implant abutment 10 according to the present invention may be disengaged from the fixture 20, or the crown may be disengaged from the implant abutment 10 according to the present invention. In the implant abutment 10 according to the present invention, only the smooth tissue contact part 10b is coated, so that a slip problem is prevented between the fixture engaging part 10c and the fixture 20 and between the crown engaging part 10a and the crown for thereby enhancing an engaging force with respect to the fixture 20 and the crown. Coating the smooth tissue contact part 10b is capable of preventing front side corrosion due to a non-oxidation acid or gap corrosion due to sodium chloride solution. The above coating process may be coating performed in an oxidation environment in the air or a noble metal coating, but is preferably a TiN coating. As shown in FIG. 3, the implant abutment 10 according to the present invention may be implemented in various types. An inner inclination contact part is formed at an upper side of the fixture 20, with an inner diameter of the inner inclination contact part decreasing in a direction from the upper side to the lower side, and a screw groove is formed at a lower side of the fixture 20. A fixture engaging part 10c is provided at a lower end of the abutment, with an outer diameter of the fixture engaging part 10c decreasing in a direction of a lower side so that the fixture engaging part 10c is inserted into the inner side of the fixture 20 and contacts with the inner inclination contact part of the fixture 20. In addition, a plurality of self-tapping grooves are formed at the lower end of the fixture 20, with the self tapping grooves being arranged symmetrically with respect to a center axes for a self-tapping process when the fixture 20 is inserted into the hole of the alveolar bone. The implant abutment 10 according to the present invention is classified into two types: threads are formed at a lower side of the fixture engaging part 10c in one type, and threads are not formed at the same side in the other type. The threads of the lower side of the fixture engaging part 10c are engaged with the threads formed at the inner inclination contact part of the fixture 20. An abutment through hole is formed at the center of the abutment 10. The abutment screw is inserted through the abutment through hole. The abutment 10 can be fixed at the top of the fixture 20 by engaging the abutment screw into the threads formed in the interior of an installation hole which is concentrically formed with the abutment through hole of the abutment 10 at the center portion of the fixture 20. With the above construction, the fixture contact part 10c of the abutment 10 contacts with the inner inclination contact part of the fixture 20 for thereby forming a conical contact link. Since the fixture engaging part 10c of the abutment 10 is not coated, there is not a slip problem, so that a strong engaging force is maintained between the fixture engaging part 10c and the fixture 20. In addition, the crown connection part 10a of the abutment 10 is not coated, so that it is not slippery, resulting in a strong engaging force with the crown. The abutment 10 directly connects the fixture 10 and the crown through the gum and is formed in a hollow cylindrical shape. The fixture engaging part 10c is formed at the lower side of the abutment 10 in response to the outer inclination contact engaging part of the upper end of the fixture 20. In the present invention, the abutment has an enhanced engaging force in such a manner that only the smooth tissue contact part is coated with TiN, while the crown connection part and the fixture engaging part are not coated. The discharges of the titanium ions due to natural oxidation of the abutment are prevented, and an anti-abrasion property is enhanced with an increase of the surface hardness. The gold color of the abutment may meet a patient's demand. An excellent smooth tissue reaction can be obtained.

### INDUSTRIAL APPLICABILITY

In the implant abutment according to the present invention, only the smooth tissue contact part of the abutment is coated with TiN, while the crown connection part and the fixture engaging part are not coated, so that it is possible to prevent a slip phenomenon between the fixture engaging part and the fixture and between the crown engaging part and the crown, whereby an engaging force with respect to the fixture and the crown can be enhanced. In addition, the discharges of the titanium ions due to natural oxidation of the abutment are prevented based on the above-described coating method, and an anti-abrasion property is enhanced with an increase of the surface hardness. The gold color of the abutment may meet a patient's demand. An excellent smooth tissue reaction can be obtained. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an abutment for a dental implant which includes a crown connection part, a smooth tissue contact part and a fixture engaging part, an improved abutment for a dental implant characterized in that only the smooth tissue contact part is coated.

2. The abutment of claim 1, wherein said abutment is made of titanium.

3. The abutment of claim 1, wherein said coating process is performed with TiN.

4. The abutment of claim 2, wherein said coating process is performed with TiN.
